(19) United States
(12) Patent Application Publication
(10) Pub. No.: US 2021/0329551 A1
(43) Pub. Date: Oct. 21, 2021

(54) LAST SEQUENCE NUMBER INDICATION

(71) Applicant: Apple Inc., Cupertino, CA (US)

(72) Inventors: Yoel BOGER, Shoham (IL); Guoqing LI, Campbell, CA (US)

(21) Appl. No.: 17/233,372

(22) Filed: Apr. 16, 2021

Related U.S. Application Data
(60) Provisional application No. 63/012,063, filed on Apr. 17, 2020.

(51) Int. Cl. H04W 52/02; H04L 29/06

(52) U.S. Cl. CPC H04W 52/0229; H04L 69/22

(57) ABSTRACT

The subject technology provides a receiving device with an indication of a last packet being transmitted in a group of packets. In this manner, the receiving device can enter a low power mode after determining that the last packet in the group of packets has been received (e.g., in addition to all prior packets in the group). For example, in the subject system a transmitting device may provide an indication of the sequence number of a last packet in the group, such as by inserting the indication into a header of one or more packets in the group of packets. In one or more implementations, each packet may include a sequence number, thus the sequence number of the last packet in the group may be the highest sequence number across the group.

### CROSS REFERENCE TO RELATED APPLICATIONS

This application claims the benefit of priority to U.S. Provisional Patent Application No. 63/012,063, entitled “Last Sequence Number Indication,” filed on Apr. 17, 2020, the disclosure of which is hereby incorporated herein in its entirety.

### TECHNICAL FIELD

The present description relates generally to providing a receiving device with a last sequence number indication, including providing a receiving device with a last sequence number indication for a particular group of packets.

### BACKGROUND

A transmitting device may transmit one or more packets to a receiving device. The receiving device may be in a normal power mode while receiving the packets and may be able to transition to a low power mode after receiving the packets.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in which a last sequence number indication may be provided in accordance with one or more implementations.

FIG. 2 illustrates an example electronic device that may be used in accordance with one or more implementations.

FIG. 3 illustrates an example timing diagram of packet bursts.

FIG. 4 illustrates a flow diagram of an example process of receiving a last sequence number indication for a group of packets in accordance with one or more implementations.

FIG. 5 illustrates an example table of control identifier subfield values in accordance with one or more implementations.

FIG. 6 illustrates an example medium access control (MAC) header format that includes a last sequence number indication in accordance with one or more implementations.

FIG. 7 illustrates another example medium access control (MAC) header format that includes a last sequence number indication in accordance with one or more implementations.

FIG. 8 illustrates an example electronic system with which aspects of the subject technology may be implemented in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Wireless communications may involve transmission of periodic traffic, such as video streaming, where an application generates packets at fixed intervals and these packets are provided to the Wi-Fi layer, via the networking layer, at a fixed schedule. In this instance, the packets will be transmitted by a transmitting device in bursts, or groups. Thus, once a receiving device receives the last packet of a group or burst of packets, the receiving device may be able to enter a low power mode, such as by powering off one or more receiver components. However, if the receiving device does not know which packet of the burst is the last packet, the receiver may need to stay awake (or in a high or normal power mode) at all times.

The subject system provides a receiving device with an indication of the last packet being transmitted in a group of packets. In this manner, the receiving device can enter a low power mode (and/or perform some other action) after determining that the last packet in the group of packets has been received (e.g., in addition to all prior packets in the group). For example, in the subject system the transmitting device may provide an indication of the sequence number of a last packet in the group, such as by inserting the indication into a header of one or more packets in the group of packets.

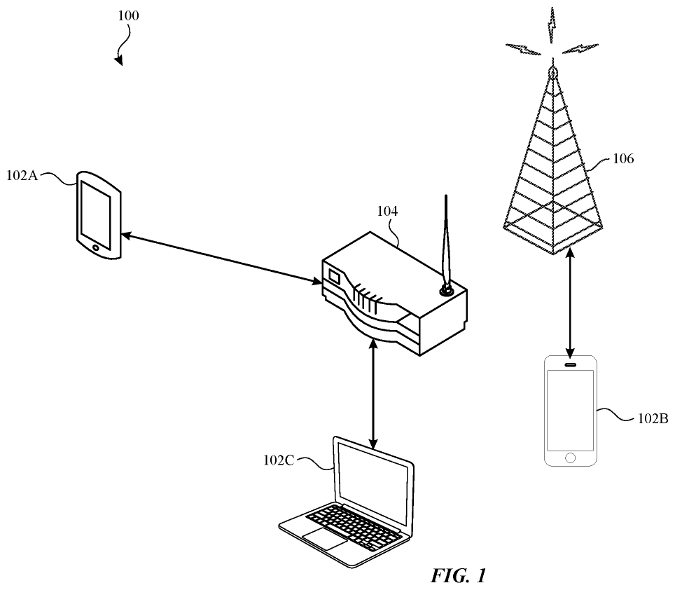

FIG. 1 illustrates an example network environment 100 in which a last sequence number indication may be provided in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes one or more electronic devices 102A-C, a wireless access point 104, and a base station 106. One or more of the electronic devices 102A-C may include, may be a component of, and/or may be referred to as, a User Equipment (UE), station (STA), or terminal device. One or more of the electronic devices 102A-C may include suitable logic, circuitry, interfaces, memory, and/or code that enables communications, e.g., with one or more of the wireless access point 104 or the base station 106, via wireless interfaces and utilizing one or more radio transceivers, such as WiFi and/or cellular transceivers. One or more of the electronic devices 102A-C may also be operable to communicate wirelessly with one or more other user devices, one or more other base stations, and/or one or more other access points not shown in FIG. 1.

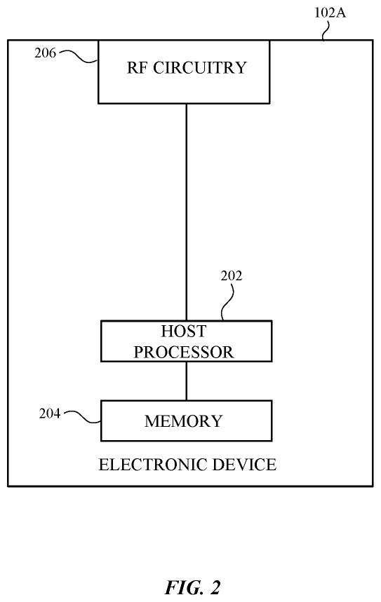

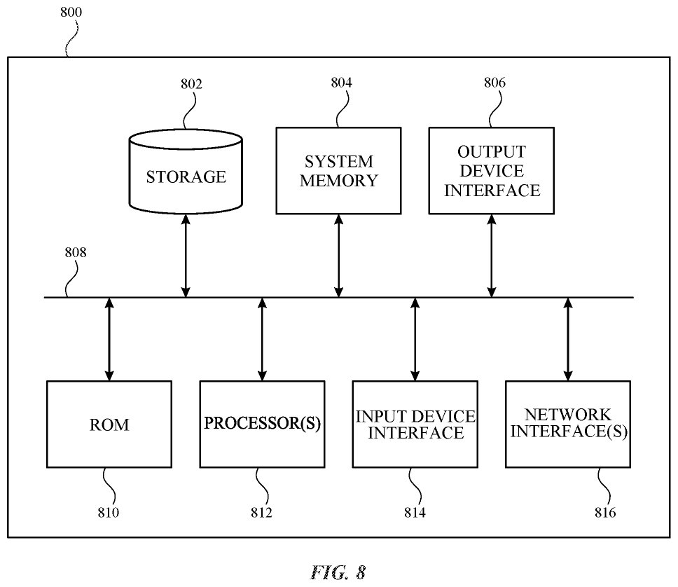

One or more of the electronic devices 102A-C may be, for example, a portable computing device such as a laptop device, a smartphone, a peripheral device (e.g., a digital camera, headphones), a smart television device, a tablet device, a wearable device such as a watch, a band, and the like, or any other appropriate device that includes, for example, one or more wireless interfaces, such as wireless local area network (WLAN) radios, Wi-Fi radios, cellular radios, Bluetooth radios, Zigbee radios, near field communication (NFC) radios, and/or other wireless radios. In FIG. 1, by way of example, the electronic device 102A is depicted as a tablet device, the electronic device 102B is depicted as a mobile device, and the electronic device 102C is depicted as a laptop device. One or more of the electronic devices 102A-C may be, and/or may include all or part of, the electronic device discussed below with respect to FIG. 2, and/or the electronic system discussed below with respect to FIG. 8.

The base station 106 may be a component of, and/or may be referred to as, a cell, a node B (NB), an evolved universal mobile telecommunications system (UMTS) terrestrial radio access network (E-UTRAN) node B, an evolved nodeB (eNodeB or eNB), and the like. The base station 106 may include suitable logic, circuitry, interfaces, memory, and/or code that enable cellular communications, e.g., with one or more of the electronic devices 102A-C and/or other base stations (not shown), via wireless interfaces and utilize one or more radio transceivers.

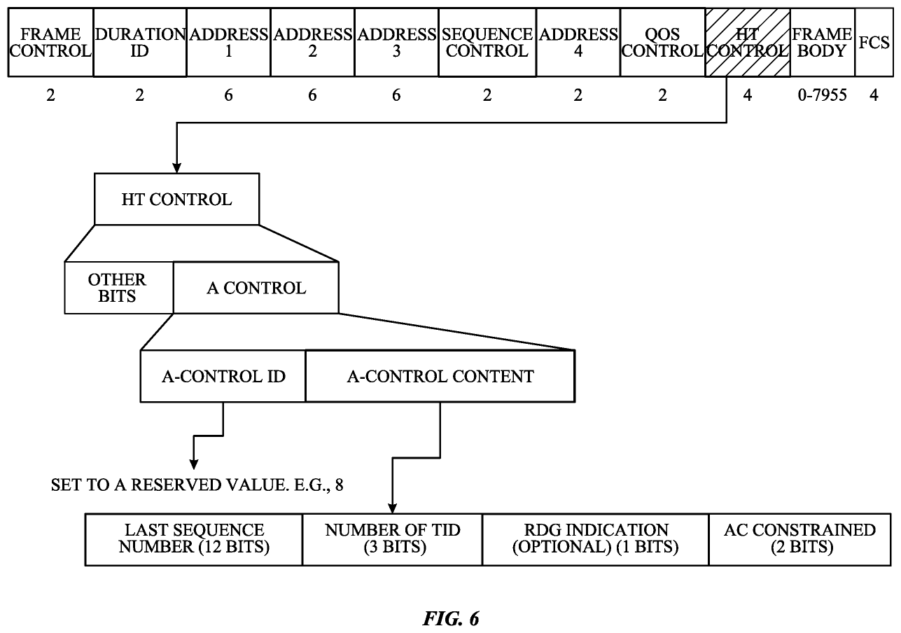

In one or more implementations, the base station 106 may be a base station of a cellular-based wireless network, such as a long term evolution (LTE) communications network, global system for mobile (GSM) communications network, UMTS communications network, or generally any cellular-based communications network. The base station 106 may utilize an unlicensed spectrum for cellular communications, such as in a carrier aggregation procedure, e.g., in licensed assisted access (LAA) communication. Thus, the cellular communications may include communications over licensed spectrum, such as spectrum licensed by the mobile network operator associated with the base station 106, and/or communications over unlicensed spectrum, such as, for example, the 5 GHz spectrum. The base station 106 may be, and/or may include all or part of, the electronic device discussed below with respect to FIG. 2, and/or the electronic system discussed below with respect to FIG. 6.

The wireless access point 104 may include, may be a component of, and/or may be referred to as, a WLAN access point. The wireless access point 104 includes suitable logic, circuitry, interfaces, memory, and/or code that enable WiFi communications, e.g., with one or more of the electronic devices 102A-C via wireless interfaces and utilize one or more radio transceivers. The WiFi communications may include communications over one or more of a 2.4 GHz spectrum, a 5 GHz spectrum, a 60 GHz spectrum, and/or other spectrums utilized for WiFi communications. The wireless access point 104 may be, and/or may include all or part of, the electronic device discussed below with respect to FIG. 2, and/or the electronic system discussed below with respect to FIG. 8.

In FIG. 1, the electronic device 102B is illustrated as participating in cellular communications with the base station 106. However, the electronic device 102B may also participate in WiFi communications with the wireless access point 104, such as concurrently with the cellular communications with the base station 106. In one or more implementations, the electronic device 102B may participate in a licensed assisted access procedure with the base station 106 in order to utilized unlicensed spectrum (e.g., spectrum that is not licensed by any mobile network operator) for cellular communications, such as via carrier aggregation. Thus, if the electronic device 102B is located near one or more of the electronic devices 102A,C that are utilizing the 5 GHz spectrum for WiFi communications, e.g. with the wireless access point 104, the WiFi communications of the electronic devices 102A,C on the 5 GHz spectrum may interfere with the cellular communications of the electronic device 102B on the 5 GHz spectrum (and vice-versa).

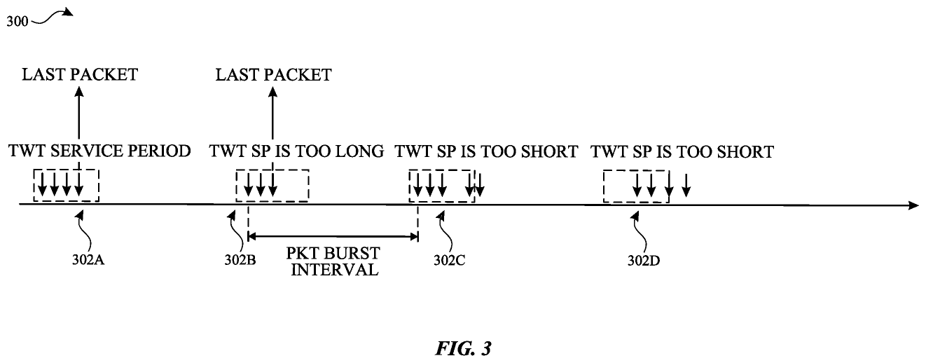

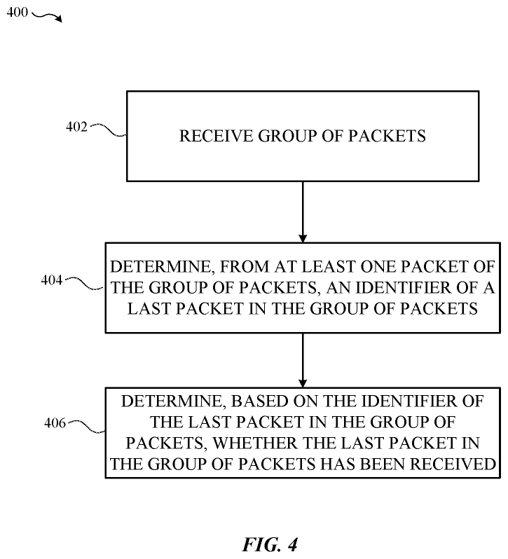

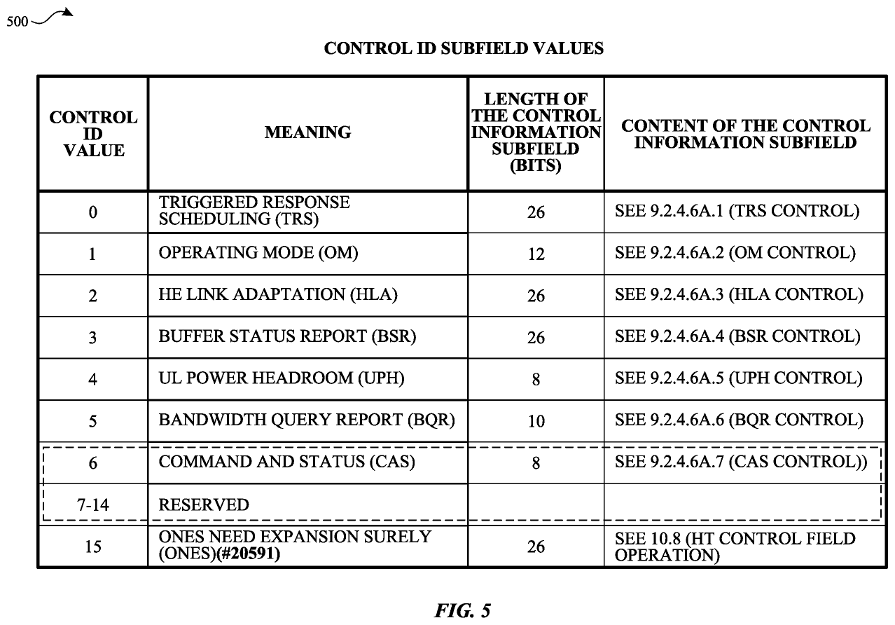

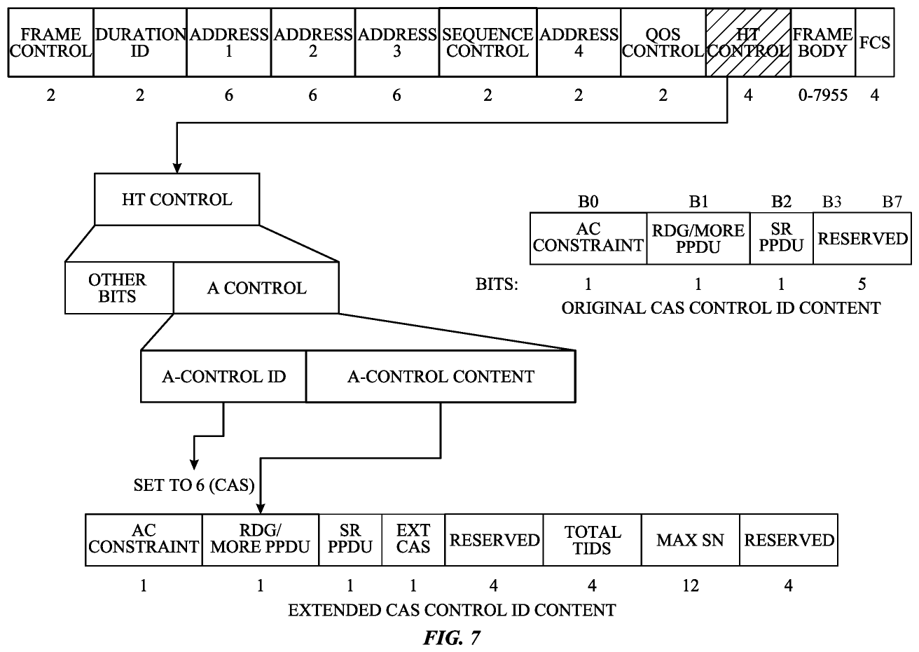

In the subject system one or more of the electronic devices 102A-C, the wireless access point 104, and/or the base station 106, such as the electronic device 102B, may transmit a last sequence number indication for each group, or burst, of packets transmitted. Another electronic device 102A may receive the last sequence number indication and use the indication to determine when to enter a low power mode. An example timing diagram illustrating the transmission of bursts of packets is discussed further below with respect to FIG. 3. An example process of the electronic device 102A receiving a last sequence number indication is discussed further below with respect to FIG. 4. An example table of control identifier subfield values is discussed further below with respect to FIG. 5, and example MAC header formats that include a last sequence number indication are discussed further below with respect to FIGS. 6 and 7.

FIG. 2 illustrates an example electronic device 102A that may be used in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided. In one or more implementations, one or more components of the example electronic device 102A may be implemented by one or more the electronic devices 102B-C, the wireless access point 104, and/or the base station 106.

The electronic device 102A may include, among other components, a host processor 202, a memory 204, and RF circuitry 206. The host processor 202, which may also be referred to as an application processor or a processor, may include suitable logic, circuitry, and/or code that enables processing data and/or controlling operations of the electronic device 102A. In this regard, the host processor 202 may be enabled to provide control signals to various other components of the electronic device 102A.

The host processor 202 may also control transfers of data between various portions of the electronic device 102A. Additionally, the host processor 202 may enable implementation of an operating system or otherwise execute code to manage operations of the electronic device 102A. The memory 204 may include suitable logic, circuitry, and/or code that enable storage of various types of information such as received data, generated data, code, and/or configuration information. The memory 204 may include, for example, random access memory (RAM), read-only memory (ROM), flash, and/or magnetic storage.

The RF circuitry 206 may include suitable logic circuitry and/or code that may be operable to transmit and receive one or more types of wireless signals, such as WiFi signals, cellular signals, and the like. For example, the RF circuitry 206 may include an RF front end, a baseband processor, and/or one or more other components that facilitate wireless communications.

In one or more implementations, one or more of the host processor 202, the memory 204, the RF circuitry 206, and/or one or more portions thereof, may be implemented in software (e.g., subroutines and code), hardware (e.g., an ASIC, an FPGA, a PLD, a controller, a state machine, gated logic, discrete hardware components, or any other suitable devices) and/or a combination of both.

FIG. 3 illustrates an example timing diagram 300 of packet bursts 302A-D. As shown in FIG. 3, the target wake time (TWT) protocol may be a protocol that can set up a periodic wake/sleep schedule between a transmitter and receiver that facilitates the devices to sleep and/or enter a low power mode. In the TWT protocol, the TWT wake duration (service period) and sleep duration may be fixed values. However, as shown in FIG. 3, there may be many instances when the TWT service period is either too short for some packet burst intervals, or too long for other packet burst intervals.

For example, the communication channels may be congested, so some transmissions may be delayed. In another example, if link quality is degraded, the transmission rate may be reduced and the transmission duration may be increased such that pending packets in the current burst interval cannot be finished in the current TWT service period. Thus, in these examples, the receiving device cannot go back to sleep after the last packet in the packet burst interval.

In the timing diagram 300, the TWT service period for the packet burst 302B is too long, and therefore the receiving device stays awake longer than necessary. For the packet bursts 302C-D, the TWT service period is too short and therefore some of the packets may not be received by the receiving device, such as if the receiving device enters a low power mode.

FIG. 4 illustrates a flow diagram of an example process 400 receiving a last sequence number indication for a group of packets in accordance with one or more implementations. For explanatory purposes, the process 400 is primarily described herein with reference to the electronic device 102A of FIGS. 1-2. However, the process 400 is not limited to the electronic device 102A of FIGS. 1-2, and one or more blocks (or operations) of the process 400 may be performed by one or more components or chips of the electronic device 102A. The electronic device 102A is also presented as an exemplary device and the operations described herein may be performed by any suitable device, such as one or more of the electronic devices 102B-C. Further for explanatory purposes, the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

The process 400 may be initiated when the electronic device 102A receives a packet of a group of packets, such as a burst of packets (402). One or more packets in the group of packets may include an identifier of a last packet in the group of packets, such as a last sequence number indication that indicates the sequence number of the last packet in the group of packets. For example, one or more of the packets may include the last sequence number indication in a control field of a header, as is discussed further below with respect to FIGS. 6-7. The last sequence number may have been inserted into the header of one or more of the packets by, for example, the transmitting device.

The electronic device 102A determines, from at least one packet of the group of packets, the identifier of the last packet in the group of packets (404). For example, the electronic device 102A may parse or extract the last sequence number indication from the header of one or more packets of the group of packets. The electronic device 102A determines, based on the determined identifier of the last packet in the group of packets, whether the last packet in the group of packets has been received (406). For example, the electronic device 102A may compare the indicated last sequence number with the highest sequence number of any received packet. In one or more implementations, the electronic device 102A may confirm that each packet of the group of packets has been received, e.g., up to an including the last packet. For example, the sequence number of the last packet may be the highest sequence number of the group of packets.

If the electronic device 102A determines that the last packet, and/or all packets up to and including the last packet, have been received, the electronic device 102A may enter a low power mode. For example, the electronic device 102A may power off its receiver and/or one or more components in the receive chain. In one or more implementations, the electronic device 102A may stay in the low power mode until the next receiving period, such as the next scheduled receiving period.

In one or more implementations, the electronic device 102A may store a data structure that maintains a record of the last sequence number indicated for each transmitting device and/or each traffic identifier (TID). When the electronic device 102A determines an increase in the last sequence number value for a received packet of a given transmitting device and/or a given traffic identifier (e.g., relative to the stored value), the electronic device 102A updates the record of the last sequence number.

In one or more implementations, one or more packets in the group of packets may also include a maximum number of traffic identifiers indication. The maximum number of traffic identifiers indication may indicate to the electronic device 102A if there are multiple traffic identifiers being transmitted even when the last sequence number is only indicated for a particular traffic identifier.

FIG. 5 illustrates an example table 500 of control identifier subfield values in accordance with one or more implementations. As shown in the table 500, a new control identifier may be established, e.g., one or more of values 7-14 may be used to create control content that includes a last sequence number indication, as is discussed further below with respect to FIG. 6. Further as shown in the table 500, an existing control identifier (such as command and status (CAS) control identifier) can be repurposed to include a last sequence number indication, as is discussed further below with respect to FIG. 7.

FIG. 6 illustrates an example medium access control (MAC) header format that includes a last sequence number indication in accordance with one or more implementations. As shown in FIG. 6, the A-control identifier for the A control field within the HT control field of the MAC header may include a reserved identifier, such as 8 (or any reserved identifier) to indicate that the A-control content includes the last sequence number indication. The last sequence number indication may be included as a 12-bit sequence number which indicates the last sequence number for the current traffic identifier carried in the payload. The A-control content may further include an indication of a number of traffic identifiers carried in the current PHY transmission unit (PPDU). The A-control content may further include an RDG (reverse direction) indication and/or an AC Constrained field to indicate to the receiver that the receiver may use the RDG protocol to transmit data after receiving the current transmission.

FIG. 7 illustrates another example medium access control (MAC) header format that includes a last sequence number indication in accordance with one or more implementations. As shown in FIG. 7, the A-control identifier may be set to 6, which as shown in the table 500 corresponds to the command and control (CAS) content. Thus, the CAS control content may be modified to carry additional information, such as the last sequence number indication, in addition to the original CAS control content, such as the AC Constraint field, the RDG/More PPDU field, and the SR PPDU field.

In the subject system, the first reserved bit (e.g. the Ext CAS indication) in the original CAS control reserve field may be used to indicate that the CAS control field includes extended CAS control information. The extended CAS control information may include, for example, the total number of TIDs, which indicates the number of TIDs in the current transmission interval, the maximum sequence number field, which indicates the last sequence number for the current TID carried in the payload, and/or the number of TIDs carried in the current PHY transmission unit (PPDU).

FIG. 8 illustrates an electronic system 800 with which one or more implementations of the subject technology may be implemented. The electronic system 800 can be, and/or can be a part of, one or more of the electronic devices 102A-C, the wireless access point 104, and/or the base station 106 shown in FIG. 1. The electronic system 800 may include various types of computer readable media and interfaces for various other types of computer readable media. The electronic system 800 includes a bus 808, one or more processing unit(s) 812, a system memory 804 (and/or buffer), a ROM 810, a permanent storage device 802, an input device interface 814, an output device interface 806, and one or more network interfaces 816, or subsets and variations thereof.

The bus 808 collectively represents all system, peripheral, and chipset buses that communicatively connect the numerous internal devices of the electronic system 800. In one or more implementations, the bus 808 communicatively connects the one or more processing unit(s) 812 with the ROM 810, the system memory 804, and the permanent storage device 802. From these various memory units, the one or more processing unit(s) 812 retrieves instructions to execute and data to process in order to execute the processes of the subject disclosure. The one or more processing unit(s) 812 can be a single processor or a multi-core processor in different implementations.

The ROM 810 stores static data and instructions that are needed by the one or more processing unit(s) 812 and other modules of the electronic system 800. The permanent storage device 802, on the other hand, may be a read-and-write memory device. The permanent storage device 802 may be a non-volatile memory unit that stores instructions and data even when the electronic system 800 is off. In one or more implementations, a mass-storage device (such as a magnetic or optical disk and its corresponding disk drive) may be used as the permanent storage device 802.

In one or more implementations, a removable storage device (such as a floppy disk, flash drive, and its corresponding disk drive) may be used as the permanent storage device 802. Like the permanent storage device 802, the system memory 804 may be a read-and-write memory device. However, unlike the permanent storage device 802, the system memory 804 may be a volatile read-and-write memory, such as random access memory. The system memory 804 may store any of the instructions and data that one or more processing unit(s) 812 may need at runtime. In one or more implementations, the processes of the subject disclosure are stored in the system memory 804, the permanent storage device 802, and/or the ROM 810. From these various memory units, the one or more processing unit(s) 812 retrieves instructions to execute and data to process in order to execute the processes of one or more implementations.

The bus 808 also connects to the input and output device interfaces 814 and 806. The input device interface 814 enables a user to communicate information and select commands to the electronic system 800. Input devices that may be used with the input device interface 814 may include, for example, alphanumeric keyboards and pointing devices (also called “cursor control devices”). The output device interface 806 may enable, for example, the display of images generated by electronic system 800. Output devices that may be used with the output device interface 806 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 8, the bus 808 also couples the electronic system 800 to one or more networks and/or to one or more network nodes, through the one or more network interface(s) 816. In this manner, the electronic system 800 can be a part of a network of computers (such as a LAN, a wide area network (“WAN”), or an Intranet, or a network of networks, such as the Internet. Any or all components of the electronic system 800 can be used in conjunction with the subject disclosure.

As described above, an aspect of the present technology may be the gathering and use of data available from specific and legitimate sources to improve the present technology. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. Further, other uses for personal information data that benefit the user are also contemplated by the present disclosure. For instance, health and fitness data may be used, in accordance with the user's preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
receiving, by an electronic device, a group of packets;
determining, from at least one packet of the group of packets, an identifier of a last packet of the group of packets;
determining, based on the identifier of the last packet of the group of packets, whether the last packet of the group of packets has been received;
responsive to determining that the last packet of the group of packets was received, performing, by the electronic device, entering a low power mode.

2. The method of claim 1, wherein each packet of the group of packets is identified by a sequence number and the identifier of the last packet of the group of packets comprises a sequence number of the last packet.

3. The method of claim 2, wherein the sequence number of the last packet comprises a highest sequence number across the group of packets.

4. The method of claim 1, wherein the at least one packet of the group of packets comprises, in a header, the identifier of the last packet of the group of packets.

5. The method of claim 4, wherein the at least one packet is separate from the last packet.

6. The method of claim 1, wherein each packet of the group of packets comprises, in a header, the identifier of the last packet of the group of packets.

7. The method of claim 6, wherein the identifier of the last packet is included in a control field of the header.

8. The method of claim 1, further comprising:
responsive to determining that the last packet of the group of packets was not received, foregoing, by the electronic device, entering the low power mode

9. A device comprising:
a memory; and
at least one processor configured to:
receive a group of packets;
determine, from at least one packet of the group of packets, an identifier associated with a last packet of the group of packets;
determine, based on the identifier of the last packet of the group of packets, whether the last packet of the group of packets has been received; and
responsive to a determination that the last packet was received, entering a low power mode.

10. The device of claim 9, wherein each packet of the group of packets is identified by a sequence number and the identifier associated with the last packet of the group of packets comprises a sequence number of the last packet.

11. The device of claim 9, wherein the sequence number of the last packet comprises a highest sequence number across the group of packets.

12. The device of claim 9, wherein the at least one packet of the group of packets comprises, in a header, the identifier of the last packet of the group of packets.

13. The device of claim 12, wherein the at least one packet is separate from the last packet of the group of packets.

14. The device of claim 9, wherein each packet of the group of packets comprises, in a header, the identifier of the last packet of the group of packets.

15. The device of claim 14, wherein the identifier of the last packet is included in a control field of the header.

16. A non-transitory machine readable medium comprising instructions that, when executed by one or more processors, cause the one or more processors to perform operations comprising:
receiving, by an electronic device, a group of packets, wherein each packet of the group of packets includes a sequence number.
determining, from at least one packet of the group of packets, a highest sequence number across the group of packets
determining, based on the highest sequence number across the group of packets, whether the last packet of the group of packets has been received; and
responsive to determining that the last packet of the group of packets was received, performing, by the electronic device, entering a low power mode.

17. The non-transitory machine readable medium of claim 16, wherein the at least one packet of the group of packets comprises, in a header, the highest sequence number across the group of packets.

18. The non-transitory machine readable medium of claim 17, wherein the at least one packet is separate from the last packet of the group of packets.

19. The non-transitory machine readable medium of claim 16, wherein each packet of the group of packets comprises, in a header, the highest sequence number of the last packet of the group of packets.

20. The non-transitory machine readable medium of claim 19, wherein the highest sequence number of the last packet is included in a control field of the header.
